(19) United States
(12) Patent Application Publication
(10) Pub. No.: US 2026/0230527 A1
(43) Pub. Date: Aug. 6, 2026

(54) INFORMATION PROCESSING METHOD

(71) Applicant: TOYOTA JIDOSHA KABUSHIKI KAISHA, Toyota-shi (JP)

(72) Inventors: Shingo SUGIMOTO, Nagoya-shi (JP); Yuma ITO, Chiryu-shi (JP); Napak JENKITTIKUL, Kasugai-shi (JP)

(73) Assignee: TOYOTA JIDOSHA KABUSHIKI KAISHA, Toyota-shi (JP)

(21) Appl. No.: 19/421,631

(22) Filed: Dec. 16, 2025

(30) Foreign Application Priority Data
Feb. 6, 2025 (JP) 2025-018769

(51) Int. Cl. H04L 67/12

(52) U.S. Cl. CPC H04L 67/12

(57) ABSTRACT

In a system including an information processing device and a plurality of vehicles that are communicably connected to each other using a mesh network, the information processing device determines, based on a predetermined condition, a vehicle, from among the vehicles, to operate as a CDN server that delivers data, sets the determined vehicle to operate as the CDN server, and sets any of the vehicles to operate as a DNS server that manages a local IP address of each of the vehicles in the mesh network. In response to receiving the request for the predetermined data from another vehicle, the vehicle operating as the DNS server notifies the local IP address of the vehicle operating as the CDN server to the other vehicle. In response to the request from the other vehicle, the vehicle operating as the CDN server delivers the predetermined data to the other vehicle.

### CROSS-REFERENCE TO RELATED APPLICATION

This application claims priority to Japanese Patent Application No. 2025-018769

filed on Feb. 6, 2025. The disclosure of the above-identified application, including the specification, drawings, and claims, is incorporated by reference herein in its entirety.

### BACKGROUND

### 1. Technical Field

The present disclosure relates to an information processing method.

2. Description of Related Art

Japanese Unexamined Patent Application Publication No. 2022-159229 (JP 2022-159229 A) discloses a mesh network in which a network interface is selected based on an operating state of a vehicle.

### SUMMARY

When a contents delivery network (CDN) is constructed using a mesh network between vehicles to deliver contents such as music and movies, a global IP address of a vehicle serving as a CDN server changes frequently, imposing an excessive management burden on DNS information at a DNS server.

An object of the present disclosure is to improve data delivery technology using a mesh network between vehicles.

According to the present disclosure,

there is provided an information processing method in a system including an information processing device and multiple vehicles connected to each other so as to be able to communicate with each other using a mesh network, the information processing method including:
determining a vehicle that operates as a CDN server that delivers data, from among the vehicles, based on a predetermined condition, the determining being performed by the information processing device;
setting the vehicle that operates as the CDN server such that the determined vehicle that operates as the CDN server operates as the CDN server, the setting being performed by the information processing device;
setting any one of the vehicles to operate as a DNS server that manages a local IP address of each of the vehicles in the mesh network, the setting being performed by the information processing device;
notifying, in response to receiving a request for predetermined data from another vehicle, the other vehicle of the local IP address of the vehicle that operates as the CDN server, the notifying being performed by the vehicle that operates as the DNS server; and
delivering, in response to the request from the other vehicle, the predetermined data to the other vehicle, the delivering being performed by the vehicle that operates as the CDN server.

According to an embodiment of the present disclosure, the data delivery technology using the mesh network between vehicles can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an example of a schematic configuration of a system according to the embodiment of the present disclosure; and

FIG. 2 is a sequence chart showing an operation example of the system according to the embodiment of the present disclosure.

### DETAILED DESCRIPTION OF EMBODIMENTS

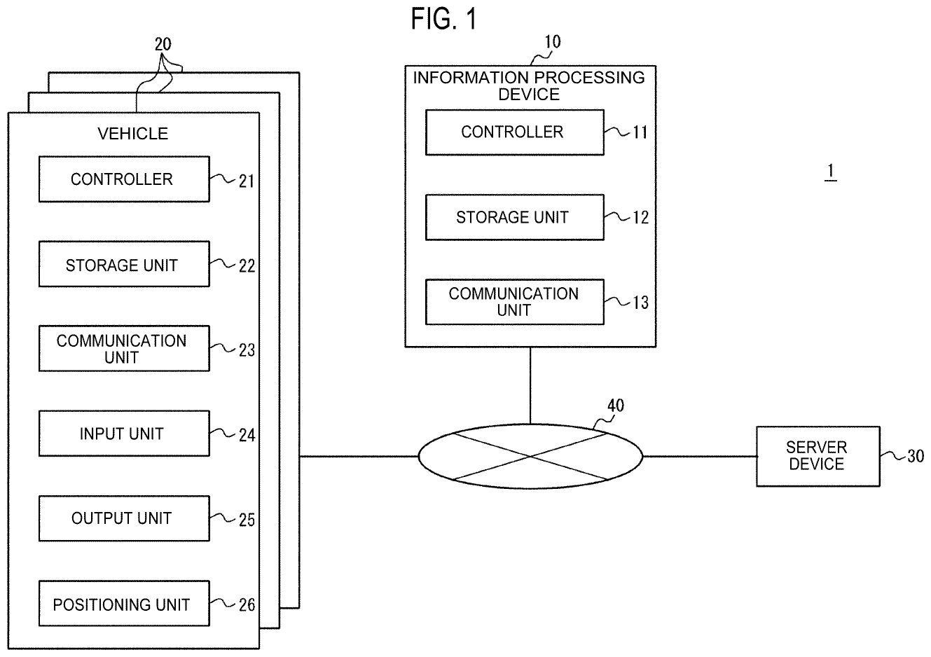

Hereinafter, an embodiment of the present disclosure will be described with reference to drawings. FIG. 1 is a diagram showing an example of a schematic configuration of a system 1 according to the embodiment of the present disclosure. The system 1 includes an information processing device 10, a plurality of vehicles 20, and a server device 30. The information processing device 10, the vehicles 20, and the server device 30 are communicably connected to each other via a network 40. The vehicles 20 can communicate with each other between vehicles using, for example, a mesh network such as Wi-Fi (registered trademark) mesh.

The information processing device 10 is, for example, a computer installed in a data center or the like. For example, the information processing device 10 may belong to a computing system such as a cloud computing system. The information processing device 10 manages data delivery of contents or the like between the vehicles 20. For example, the information processing device 10 may manage information such as whether the predetermined data is cached in each of the vehicles 20 and the vehicles 20 operating as CDN servers/DNS servers. The information processing device 10 may acquire information such as a power resource, a position, a destination, a communication state, a communication cost, a load, and an operational state of each of the vehicles 20 by communicating with each of the vehicles 20.

The vehicles 20 travel on a roadway to move people, things, and the like. Each of the vehicles 20 may be, for example, a gasoline vehicle, a battery electric vehicle (EV: Electric Vehicle), a hybrid electric vehicle (HV: Hybrid Vehicle), a plug-in hybrid electric vehicle (PHV: Plug-in Hybrid Vehicle), a fuel cell electric vehicle (FCV: Fuel Cell Vehicle), or the like. Each of the vehicles 20 may be, for example, a vehicle capable of autonomous driving of any of levels 1 to 5 as defined by the Society of Automotive Engineers (SAE). The number of vehicles 20 included in the system 1 may be randomly determined.

The server device 30 is a computer that performs data delivery. For example, the server device 30 may belong to a computing system such as a cloud computing system. The data delivered by the server device 30 may be, for example, any streaming content such as music or movies. The network 40 is any communication medium that enables communication between devices. For example, the network 40 may include the Internet and a mobile communication network. The number of information processing devices 10 and server devices 30 included in the system 1 is not limited.

The system 1 sets a contents delivery network (CDN) in the mesh network constructed between the vehicles 20 and delivers data including contents. Each of the vehicles 20 is assigned a global Internet Protocol (IP) address for communicating in the network 40. In addition, each of the vehicles 20 is assigned a local IP address for communicating in the mesh network. Here, the global IP address of each of the vehicles 20 may change frequently due to movement or the like, whereas the local IP address does not change.

In such a configuration, the information processing device 10 determines, based on the predetermined condition, the vehicle 20, from among the vehicles 20, to operate as the CDN server that delivers the data. The information processing device 10 sets the vehicle 20 such that the vehicle 20 that is determined to operate as the CDN server operates as the CDN server. The information processing device 10 sets any vehicle 20, from among the vehicles 20, to operate as a DNS server that manages the local IP address of each of the vehicles 20 in the mesh network. In response to receiving the request for the predetermined data from another vehicle 20, the vehicle 20 operating as the DNS server notifies the local IP address of the vehicle 20 operating as the CDN server to the other vehicle 20. In response to the request from the other vehicle 20, the vehicle 20 operating as the CDN server delivers the predetermined data to the other vehicle 20.

As shown in FIG. 1, the information processing device 10 includes a controller 11, a storage unit 12, and a communication unit 13. The controller 11 includes at least one processor. The processor is a general-purpose processor such as a central processing unit (CPU) or a dedicated processor. The controller 11 controls each unit of the information processing device 10. The storage unit 12 includes at least one semiconductor memory, magnetic memory, optical memory, or the like. The storage unit 12 functions as, for example, a main memory, an auxiliary memory, or the like. The storage unit 12 stores data used for the operation of the information processing device 10 and data obtained by the operation. The communication unit 13 includes at least one external communication interface. The communication interface may be any interface of wired communication or wireless communication. In a case of wired communication, the communication interface is, for example, a local area network (LAN). In a case of wireless communication, the communication interface is, for example, an interface corresponding to a mobile communication standard such as 5G, an interface corresponding to short-range wireless communication, or the like. The communication unit 13 receives data used for the operation of the information processing device 10 or transmits data obtained by the operation. The information processing device 10 may be realized by a single computer or may be realized by cooperation of a plurality of computers. The functions of the information processing device 10 are realized by executing a program according to the present embodiment by a processor corresponding to the controller 11. That is, the functions of the information processing device 10 are realized by software. The program causes the computer to execute the operation of the information processing device 10, thereby enabling the computer to function as the information processing device 10. That is, the computer functions as the information processing device 10 by executing the operation of the information processing device 10 in accordance with the program. A part or all of the functions of the information processing device 10 may be realized by a dedicated circuit corresponding to the controller 11. That is, a part or all of the functions of the information processing device 10 may be realized by hardware.

As shown in FIG. 1, the vehicle 20 includes a controller 21, a storage unit 22, a communication unit 23, an input unit 24, an output unit 25, and a positioning unit 26. Since functions and configurations of the controller 21 and the storage unit 22 of the vehicle 20 are the same as those of the controller 11 and the storage unit 12 of the information processing device 10, detailed descriptions thereof will be omitted. The communication unit 23 may also be the same as the communication unit 13 of the information processing device 10. However, the communication unit 23 may include, for example, an interface corresponding to a mobile communication standard or the like for connecting to the network 40 and an interface corresponding to a wireless LAN or the like for connecting to the mesh network with the other vehicle 20. The communication unit 13 receives data used for the operation of the vehicle 20 and transmits data obtained by the operation of the vehicle 20. The input unit 24 includes at least one input interface for receiving an operation from a user. The input interface may be, for example, a physical key, a touch screen, or the like. The output unit 25 includes at least one output interface. The output interface is, for example, a display that outputs information visually, a speaker that outputs information audibly, or the like. The output unit 25 outputs the data to the user. The positioning unit 26 includes one or more devices that acquire position information of the vehicle 20. The positioning unit 26 may include, for example, a receiver corresponding to any satellite positioning system such as a global positioning system (GPS). A part or all of the functions of the vehicle 20 may be realized by software.

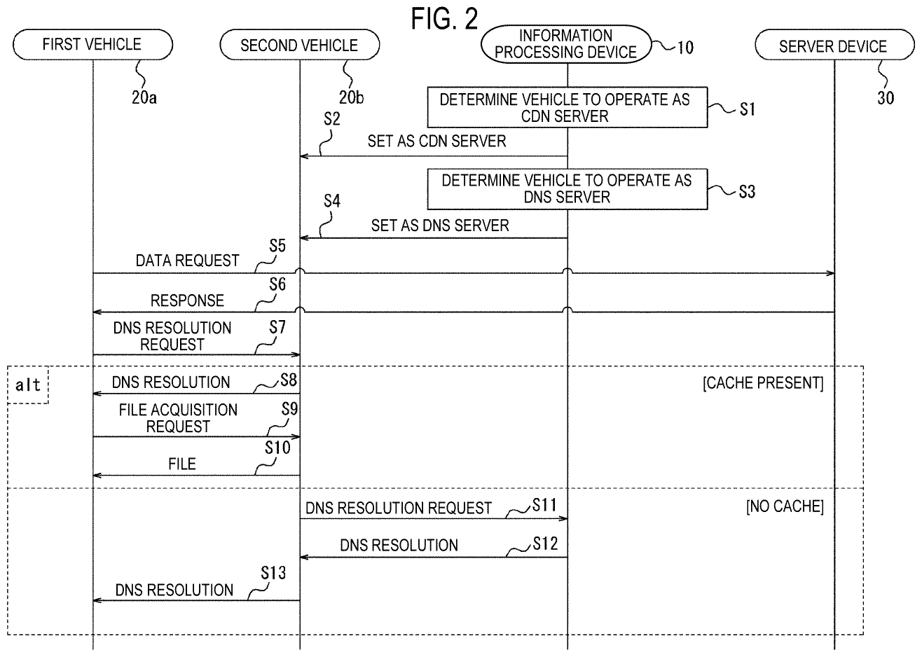

FIG. 2 is a sequence chart showing an operation example of the system 1 according to the embodiment of the present disclosure. The operation of the system 1 described with reference to FIG. 2 may correspond to one of the information processing methods of the system 1.

S1: The controller 11 of the information processing device 10 determines, based on the predetermined condition, the vehicle 20, from among the vehicles 20, to operate as the CDN server that delivers the data including the content such as music or movies. The predetermined condition may be a condition related to at least one of the power resource, the position, the destination, the communication state, the communication cost, the load, and the operational state of each of the vehicles 20. For example, the controller 11 acquires the information on the power resource based on information such as whether the vehicle 20 is an EV/PHV, whether the vehicle 20 is being charged, or whether the vehicle 20 is stopped with the engine running. The controller 11 may determine the vehicle 20 having a larger power resource as the CDN server that performs the content delivery with higher priority. The controller 11 may determine the vehicle 20 operating as the CDN server based on a communication delay, a geographical position of the vehicle 20, a communication cost (for example, a communication charge including a charge per unit data amount for each vehicle 20), or the like. The controller 11 may determine a vehicle 20 to operate as a CDN server based on the load and the operational state of the vehicle 20, such as whether autonomous driving is active, whether the meters are operating, or whether the infotainment system is in use. The information processing device 10 may acquire, from the vehicles 20 that are autonomous driving vehicles or vehicles that travel with a car navigation system, information such as the positions, the operational states, and the like of the vehicles 20 in the present and the future, and determine which vehicle 20 will operate as the CDN server.

S2: The controller 11 of the information processing device 10 sets the vehicle 20 to operate as the CDN server such that the vehicle 20 that is determined in S1 to operate as the CDN server operates as the CDN server. In the example of FIG. 2, the second vehicle 20b is set as the CDN server.

S3: The controller 11 of the information processing device 10 determines, based on a predetermined condition, the vehicle 20, from among the vehicles 20, to operate as the DNS server that manages the local IP address of each of the vehicles 20 in the mesh network. The vehicle 20 operating as the DNS server may be the same vehicle 20 as the vehicle 20 operating as the CDN server or may be a different vehicle 20.

S4: The controller 11 of the information processing device 10 sets the vehicle 20 to operate as the DNS server such that the vehicle 20 that is determined in S3 to operate as the DNS server operates as the DNS server. In the example of FIG. 2, the second vehicle 20b is set as not only the CDN server but also the DNS server.

S5: The controller 21 of the first vehicle 20a requests the data from the server device 30. For example, the controller 21 may request the playback of a song of the music streaming (predetermined data) via an HTTP request (for example, “https://{StreamingServer}/music? title=xxx&id=xxx”).

S6: The server device 30 responds to the request from the first vehicle 20a by indicating access to the acquisition source of the file. For example, the server device 30 may prompt the first vehicle 20a to connect to the acquisition source of the file of the music streaming via an HTTP response (for example, “https://{musicCDN.com}/music? filename=xxx”).

S7: The controller 21 of the first vehicle 20a requests DNS resolution from the second vehicle 20b set as the DNS server. For example, the controller 21 queries the second vehicle 20b for the local IP address of “musicCDN.com” notified from the server device 30. The controller 21 of the second vehicle 20b determines whether the requested predetermined data is cached in the second vehicle 20b in response to a query from the first vehicle 20a. The controller 21 of the second vehicle 20b performs the processes of S8 to S10 when the cache is present, and performs the processes of S11 to S13 when the cache is not present.

S8: In response to receiving the request for the predetermined data from another vehicle 20 (the first vehicle 20a), the controller 21 of the second vehicle 20b notifies the local IP address of the vehicle 20 operating as the CDN server to the other vehicle 20 (the first vehicle 20a). In the example of FIG. 2, since the second vehicle 20b operates as the CDN server as well, the controller 21 notifies the first vehicle 20a of the local IP address (for example, “192.168.1.1”) of the second vehicle 20b to perform DNS resolution.

S9: The controller 21 of the first vehicle 20a requests the file of the predetermined data from the vehicle 20 (the second vehicle 20b) having the local IP address (for example, “192.168.1.1”) notified in S8. For example, the controller 21 may request the playback of a song of the music streaming (predetermined data) via an HTTP request (for example, “https://{192.168.1.1}/music? title=xxx&id=xxx”).

S10: In response to the request from the first vehicle 20a, the controller 21 of the second vehicle 20b transmits the file of the predetermined data cached in the second vehicle 20b to the first vehicle 20a.

S11: On the other hand, when the predetermined data is not cached in the second vehicle 20b, the controller 21 of the second vehicle 20b issues a re-query to the information processing device 10 to request DNS resolution.

S12: In response to the request from the other vehicle 20 (the first vehicle 20a) via the second vehicle 20b, the controller 11 of the information processing device 10 determines the delivery status of the predetermined data. Specifically, the controller 11 may determine the vehicle 20 near the first vehicle 20a set as the CDN server for the predetermined data. The controller 11 may determine, based on information such as the data cached by each of the vehicles 20, the positional relationship, the communication environment, and the state of the resource, the vehicle 20 suitable for delivering the predetermined data to the first vehicle 20a. The controller 11, based on the determination result, transmits the URL for the acquisition source of all or a part of the predetermined data that is undelivered to the second vehicle 20b to perform DNS resolution, and notifies the other vehicle 20 (the first vehicle 20a) that has made the request via the second vehicle 20b. Here, the URL is a URL including a local IP address for accessing the vehicle 20 suitable for delivering the predetermined data. The controller 11 may update the DNS information in response to the recursive query from the second vehicle 20b operating as the DNS server.

S13: The controller 21 of the second vehicle 20b notifies the first vehicle 20a of the URL notified from the information processing device 10 to perform DNS resolution. The controller 21 of the first vehicle 20a requests the file of the predetermined data from the vehicle 20 having the local IP address (for example, “192.168.1.2”) included in the URL notified in S13, and receives the predetermined data.

When the predetermined data is received by S10 or S13, the first vehicle 20a plays back and outputs the predetermined data from the output unit 25. The predetermined data received by the first vehicle 20a may be cached in the storage unit 22, so that the first vehicle 20a can subsequently operate as the CDN server for the predetermined data. As described above, the system 1 includes the information processing device 10 and the vehicles 20 that are communicably connected to each other using the mesh network. The information processing device 10 operating as the traffic management server constructs the CDN server on any of the vehicles 20 based on the information on the resources of the vehicles 20. The information processing device 10 constructs the DNS server that manages the local IP address in the mesh network on any of the vehicles 20. When the file of the content is not cached in the vehicle 20, the vehicle 20, on which the DNS server is constructed, performs the DNS recursive query to the information processing device 10. As described above, in system 1, any of the vehicles 20 operates as a DNS server and manages the local IP address of each vehicle 20 in the mesh network serving as a local network. Therefore, even when the global IP address changes due to the movement of the vehicle 20 or the like, the vehicle 20 operating as the CDN server can be specified by the same IP address. Therefore, according to the configuration of the present disclosure, the management burden of the DNS information on the DNS server can be reduced, and the data delivery technology using the mesh network between the vehicles can be improved.

The controller 11 may periodically receive the latest information on the predetermined condition from each of the vehicles 20, and update the vehicle 20 operating as the CDN server, the vehicle 20 operating as the DNS server, and the content of the DNS. When the vehicle 20 operating as the CDN server that holds the entire file of the content is not present near the vehicle 20 that has requested the content, the CDN server that holds a part of the content may start the content delivery. The vehicle 20 that has requested the content may rewrite the URL during the playback of the content to download the remaining file. The switching timing of the vehicle 20 operating as the CDN server may also be when the download of the remaining file is determined to be impossible based on the number of retries and the time. The switching destination of the vehicle 20 operating as the CDN server may be determined based on the file information held by each of the vehicles 20 managed in the information processing device 10. When the content is provided as a single file, information on how much of the file has been downloaded may be transmitted to the information processing device 10, and the information processing device 10 may determine the switching destination based on this information. When the content is provided as segmented files, the information processing device 10 may determine the segmented files corresponding to the remaining files and determine the vehicle 20 that holds the remaining files as the switching destination. The present disclosure is not limited to the embodiment described above, and modifications can be made within the scope of the spirit.

What is claimed is:

1. An information processing method in a system including an information processing device and multiple vehicles connected to each other so as to be able to communicate with each other using a mesh network, the information processing method comprising:
determining a vehicle that operates as a CDN server that delivers data, from among the vehicles, based on a condition related to at least one of a power resource, a position, a destination, a communication state, a communication cost, a load, and a state of each of the vehicles, the determining being performed by the information processing device;
setting the vehicle that operates as the CDN server such that the determined vehicle that operates as the CDN server operates as the CDN server, the setting being performed by the information processing device;
setting any one of the vehicles to operate as a DNS server that manages a local IP address of each of the vehicles in the mesh network, the setting being performed by the information processing device;
notifying, in response to receiving a request for predetermined data from another vehicle, the other vehicle of the local IP address of the vehicle that operates as the CDN server, the notifying being performed by the vehicle that operates as the DNS server; and
delivering, in response to the request from the other vehicle, the predetermined data to the other vehicle, the delivering being performed by the vehicle that operates as the CDN server.

2. An information processing method in a system including an information processing device and multiple vehicles connected to each other so as to be able to communicate with each other using a mesh network, the information processing method comprising:
determining a vehicle that operates as a CDN server that delivers data, from among the vehicles, based on a predetermined condition, the determining being performed by the information processing device;
setting the vehicle that operates as the CDN server such that the determined vehicle that operates as the CDN server operates as the CDN server, the setting being performed by the information processing device;
setting any one of the vehicles to operate as a DNS server that manages a local IP address of each of the vehicles in the mesh network, the setting being performed by the information processing device;
notifying, in response to receiving a request for predetermined data from another vehicle, the other vehicle of the local IP address of the vehicle that operates as the CDN server, the notifying being performed by the vehicle that operates as the DNS server; and
delivering, in response to the request from the other vehicle, the predetermined data to the other vehicle, the delivering being performed by the vehicle that operates as the CDN server.

3. The information processing method according to claim 2, wherein the vehicle that operates as the DNS server and the vehicle that operates as the CDN server are the same vehicle.

4. The information processing method according to claim 2, wherein the vehicle that operates as the DNS server is configured to issue, when the predetermined data is not cached in the vehicle that operates as the DNS server, a recursive query to the information processing device.

5. The information processing method according to claim 2, wherein:
the information processing device is configured to determine, in response to the request from the other vehicle, a delivery status of the predetermined data; and
the information processing device is configured to notify the other vehicle that has made the request of a URL for an acquisition source of all or a part of the predetermined data that is undelivered.
